(19) United States
(12) Patent Application Publication
(10) Pub. No.: US 2007/0218439 A1
(43) Pub. Date: Sep. 20, 2007

(54) COGNITIVE TRAINING USING VISUAL SEARCHES

(75) Inventors: Peter B. Delahunt, San Mateo, CA (US); Joseph L. Hardy, Richmond, CA (US); Henry W. Mahncke, San Francisco, CA (US); Michael M. Merzenich, San Francisco, CA (US)

Correspondence Address: HUFFMAN LAW GROUP, P.C., 1900 MESA AVE., COLORADO SPRINGS, CO, 80906, US

(73) Assignee: POSIT SCIENCE CORPORATION, San Francisco, CA (US)

(21) Appl. No.: 11/611,232

(22) Filed: Dec. 15, 2006

Related U.S. Application Data
(60) Provisional application No. 60/750,509, filed on Dec. 15, 2005.
(60) Provisional application No. 60/762,433, filed on Jan. 26, 2006.
(60) Provisional application No. 60/828,316, filed on Oct. 5, 2006.

(51) Int. Cl. G09B 19/00

(52) U.S. Cl. 434/236

(57) ABSTRACT

Computer-implemented method for enhancing cognition of a participant using visual search. A target image and distracter image are provided for visual presentation. Multiple images, including the target image and multiple distracter images based on the distracter image, are temporarily visually presented at respective locations, then removed. The participant selects the target image location from multiple locations in the visual field, and the selection's correctness/incorrectness is determined. The visually presenting, requiring, and determining are repeated to improve the participant's cognition, e.g., efficiency, capacity and effective spatial extent of a participant's visual attention. In a dual attention version, potential target images differing by a specified attribute are provided, one of which is the target image. An indication of the specified attribute is also displayed. The participant selects the location of the target image from the multiple locations, including the locations of the potential target images, based on the indication.

### CROSS REFERENCE TO RELATED APPLICATION(S)

This application claims the benefit of the following U.S. Provisional Patent Applications, which are incorporated herein in their entirety for all purposes:

| | | | |
|---|---|---|---|
| PS.0119 | 60/750509 | Dec. 15, 2005 | HAWKEYE ASSESSMENTS |
| | | | SPECIFICATION |
| PS.0122 | 60/762433 | Jan. 26, 2006 | COMPUTER BASED TRAINING |
| | | | PROGRAM TO REVERSE AGE |
| | | | RELATED DECLINES IN |
| | | | VISUAL SEARCH |
| PS.0230 | 60/828316 | Oct. 5, 2006 | VISUAL EMPHASIS |

The following applications are related to the present application, and are hereby incorporated by reference in their entirety for all purposes:

| | | | |
|---|---|---|---|
| PS.0217 | ******* | ******* | COGNITIVE TRAINING USING |
| | | | VISUAL SWEEPS |
| PS.0219 | ******* | ******* | COGNITIVE TRAINING USING |
| | | | MULTIPLE OBJECT TRACKING |
| PS.0220 | ******* | ******* | COGNITIVE TRAINING USING |
| | | | FACE-NAME ASSOCIATIONS |
| PS.0225 | ******* | ******* | COGNITIVE TRAINING USING |
| | | | EYE MOVEMENT |
| PS.0229 | ******* | ******* | COGNITIVE TRAINING USING |
| | | | VISUAL STIMULI |
| PS.0230 | ******* | ******* | VISUAL EMPHASIS FOR |
| | | | COGNITIVE TRAINING |

### FIELD OF THE INVENTION

This invention relates in general to the use of brain health programs utilizing brain plasticity to enhance human performance and correct neurological disorders, and more specifically, to a method for improving a participant's cognition, e.g., improving the ability of the visual nervous system to search for objects in a visual scene, and the efficiency and capacity of visual attentional processing.

### BACKGROUND OF THE INVENTION

Almost every individual has a measurable deterioration of cognitive abilities as he or she ages. The experience of this decline may begin with occasional lapses in memory in one's thirties, such as increasing difficulty in remembering names and faces, and often progresses to more frequent lapses as one ages in which there is passing difficulty recalling the names of objects, or remembering a sequence of instructions to follow directions from one place to another. Typically, such decline accelerates in one's fifties and over subsequent decades, such that these lapses become noticeably more frequent. This is commonly dismissed as simply “a senior moment” or “getting older.” In reality, this decline is to be expected and is predictable. It is often clinically referred to as “age-related cognitive decline,” or “age-associated memory impairment.” While often viewed (especially against more serious illnesses) as benign, such predictable age-related cognitive decline can severely alter quality of life by making daily tasks (e.g., driving a car, remembering the names of old friends) difficult.

As a more specific example, the ability to extract information from a scene reduces with age. This is thought to be due to declines in visual sensory function, slower visual processing, declines in divided attention, and the ability to ignore distracters (e.g., irrelevant objects in a scene). Declines with age have been shown for detecting objects in peripheral vision. However, the largest declines are shown for conditions where a participant must distribute attention across a visual scene.

In many older adults, age-related cognitive decline leads to a more severe condition now known as Mild Cognitive Impairment (MCI), in which sufferers show specific sharp declines in cognitive function relative to their historical lifetime abilities while not meeting the formal clinical criteria for dementia. MCI is now recognized to be a likely prodromal condition to Alzheimer's Disease (AD) which represents the final collapse of cognitive abilities in an older adult. The development of novel therapies to prevent the onset of this devastating neurological disorder is a key goal for modern medical science.

The majority of the experimental efforts directed toward developing new strategies for ameliorating the cognitive and memory impacts of aging have focused on blocking and possibly reversing the pathological processes associated with the physical deterioration of the brain. However, the positive benefits provided by available therapeutic approaches (most notably, the cholinesterase inhibitors) have been modest to date in AD, and are not approved for earlier stages of memory and cognitive loss such as age-related cognitive decline and MCI.

Cognitive training is another potentially potent therapeutic approach to the problems of age-related cognitive decline, MCI, and AD. This approach typically employs computer- or clinician-guided training to teach subjects cognitive strategies to mitigate their memory loss. Although moderate gains in memory and cognitive abilities have been recorded with cognitive training, the general applicability of this approach has been significantly limited by two factors: 1) Lack of Generalization; and 2) Lack of enduring effect.

Lack of Generalization: Training benefits typically do not generalize beyond the trained skills to other types of cognitive tasks or to other “real-world” behavioral abilities. As a result, effecting significant changes in overall cognitive status would require exhaustive training of all relevant abilities, which is typically infeasible given time constraints on training.

Lack of Enduring Effect: Training benefits generally do not endure for significant periods of time following the end of training. As a result, cognitive training has appeared infeasible given the time available for training sessions, particularly from people who suffer only early cognitive impairments and may still be quite busy with daily activities.

As a result of overall moderate efficacy, lack of generalization, and lack of enduring effect, no cognitive training strategies are broadly applied to the problems of age-related cognitive decline, and to date they have had negligible commercial impacts. The applicants believe that a significantly innovative type of training can be developed that will surmount these challenges and lead to fundamental improvements in the treatment of age-related cognitive decline. This innovation is based on a deep understanding of the science of “brain plasticity” that has emerged from basic research in neuroscience over the past twenty years, which only now through the application of computer technology can be brought out of the laboratory and into the everyday therapeutic treatment.

Thus, improved systems and methods for improving the ability of the visual nervous system of a participant to search for objects in a visual scene are desired.

### SUMMARY

Various embodiments of a system and method for improving a participant's cognition, e.g., the ability of the visual nervous system to search for objects in a visual scene, and the efficiency and capacity of visual attentional processing, are presented.

A target image and a distracter image may be provided, where the target image and the distracter image differ in appearance, and where the target image and distracter image are available for visual presentation to the participant. For example, each image may illustrate an object, such as an animal, with any of various distinguishing attributes, e.g., that may distinguish the species or sub-species illustrated in the image, e.g., size, object type, object orientation, texture, shape, etc., i.e., any visual attributes whereby the target image may be distinguished from the distracter image. In preferred embodiments, the target image may be a first species of bird, and the distracter image may be a second, different, but possibly related, species or sub-species of bird, e.g., first and second species of gulls, owls, hawks, etc. In other embodiments, the species may be unrelated.

In a single attention visual search task, e.g., Task 1, only the target image and the distracter image may be provided. However, in a dual attention task, e.g., Task 2, in addition to the distracter image, at least two potential target images may be provided, where one of the potential target images is the target image. The potential target images may differ from each other by a specified attribute, e.g., species of bird, or orientation of the object in the image. For example, in a case where there are two potential target images, the two potential target images may be mirror images of one another, where one potential target image illustrates a bird tilted to the right, and the other potential target image illustrates a bird tilted to the left. Note, however, that all the potential target images are particularly distinct with respect to the distracter images. In other words, the differences between the potential target images and the distracter images are significantly greater than the differences between the potential target images.

A plurality of images may be visually presented at respective locations in a visual field to the participant for a specified presentation time, including the target image and a plurality of distracter images based on the distracter image, where at the end of the specified presentation time the visually presenting is ceased. In other words, in addition to the target image, multiple instances of the distracter image may also be displayed, where these distracter images may be identical, or in some embodiments may include rotated versions of the original image, i.e., the distracter image, where the images are displayed for a specified period of time (the presentation time), then removed from the display. In some embodiments, the distracter images may be placed according to some specified scheme, e.g., at some specified eccentricity, according to a perturbed regular grid, e.g., a polar coordinate grid, a 2-dimensional low-discrepancy sequence, etc., as desired, while in other embodiments, the distracter images may be displayed at random positions in the visual field.

In some embodiments, the background may be somewhat simple, e.g., a lightly clouded blue sky, and so may not make visual search of the visual field more difficult. However, under different search conditions, the background may be more complex and confusing to the participant, thereby making visual searches more difficult. It should be noted that in some embodiments, the target and distracter images may be presented against background scenes that make target/distracter distinction more or less difficult based on covariance of image characteristics in the target/distracters and background scene elements, referred to as visual emphasis, described in more detail below. In other words, factors other than the complexity of the background may contribute to the ease or difficulty of distinguishing the target and/or distracters, with respect to the background, such as, for example, the degree of camouflage of the target image and/or the distracters with respect to the background, among others.

In some embodiments, prior to presentation of the target and distracter images, the target image may be displayed, e.g., in the center of the visual field, allowing the participant to familiarize himself/herself with the target. In various embodiments, the target image may be displayed for a specified duration, or may remain displayed until dismissed by the participant. In other words, in some embodiments, prior to the visually presenting the plurality of images, the method may include presenting the target image, then removing the target image.

In preferred embodiments, visually presenting the plurality of image may include visually presenting the plurality of images at a specified stimulus intensity, where, as used herein, the term “stimulus intensity” refers to an adjustable stimulus attribute or adaptive dimension that may be modified to make the search more or less difficult. For example, in a preferred embodiment, the stimulus intensity may be or include the presentation time for the visually presenting above. In other words, the stimulus intensity may be the duration of time for which the plurality of images (and in the dual attention tasks, the indicator as well) is displayed. Of course, in other embodiments, other attributes may be used for stimulus intensity as desired.

In some embodiments, the relative difference in appearance between the target and distracters may be manipulated, where the more similar the two are, the more information must be extracted from each image by the participant, thus placing greater demand on the visual attentional system.

The participant may be required to select a location of the target image from among a plurality of locations in the visual field. In other words, the participant may be required to indicate where in the visual field the target image was displayed. The participant may (attempt to) select the location of the target image in any of a number of ways. For example, in one embodiment, selection of a location of an image may be performed by the participant placing a cursor over the location and clicking a mouse. In a preferred embodiment, the visual field may be partitioned into a plurality of graphically indicated regions, where the location of the target image comprises a specified region of the plurality of regions in the visual field, i.e., the target image is contained in a specified region of the visual field. In preferred embodiments, the selection grid isn't displayed until the images are removed from the visual field.

Thus, in some embodiments, selection of a location of an image is performed by the participant placing a cursor over (or in) a region that contained the image and clicking a mouse.

In some embodiments, there may be multiple presentations of target/distracter sets shown before the participant makes a response. For example, 3 sets of target/distracter sets (scenes) may be visually presented, after which the participant may be required to respond, indicating the order of locations (selectable regions) where the targets appeared in each set. In other words, a sequence of target/distracter/background scenes may be presented, after which the participant may be required to indicate the corresponding sequence of target image locations (regions).

A determination may then be made as to whether the participant selected the location of the target image (or sequence of target image locations) correctly. In some embodiments, whether the participant correctly selected the location of the target image (or not) may be recorded. In some embodiments, an indication, e.g., a graphical or audible indication, may be provided to the participant indicating the correctness or incorrectness of the participant's response. For example, a “ding” or a “thunk” may be played to indicate correctness or incorrectness, respectively, and/or points may be awarded (in the case of a correct response). Of course, any other type of indication may be used as desired. The above visually presenting, requiring, and determining, may compose a trial in the exercise or task.

In some embodiments, the participant may perform the exercise or tasks via a graphical user interface (GUI), which may include a stimulus presentation area where the images may be presented to the participant, as well as means for receiving input from the participant, e.g., the selectable regions described above. Moreover, in some embodiments, additional GUI elements may be provided, e.g., for indicating various aspects of the participant's progress or status with respect to the exercise or task.

The visually presenting, requiring, and determining may be repeated one or more times in an iterative manner, to improve the participant's cognition, e.g., efficiency, capacity and effective spatial extent of visual attentional processing, e.g., the participant's visual processing skills.

In other words, a plurality of trials may be performed in the exercise (with respect to either or both tasks), where various search fields and images are visually presented to the participant, as described above. For example, the repetitions may be performed over a plurality of sessions, e.g., over days, weeks, or even months, e.g., for a specified number of times per day, and for a specified number of days. In some embodiments, at the end of each session, the participant's score and thresholds for the session may be shown and may be compared to the best performance.

Such repeating preferably includes trials performed under a variety of specified search conditions, wherein each visual search condition specifies one or more attributes of the plurality of images or their presentation, e.g., with visual searches covering a range of search attributes. Such conditions may include baseline conditions, used before, after, and at specified points during, the exercise to assess the participant's performance (described further below), and non-baseline or training conditions, used for the actual training during the exercise. Thus, blocks of stimuli may contain particular conditions affecting the difficulty of the searches.

In some embodiments, trials in the exercise may be directed to a single visual search task, e.g., to a single attention visual search task, or a dual attention visual search task; however, as mentioned above, in preferred embodiments, the repeating may include performing trials in each of the visual search tasks (e.g., the single and dual attention visual search tasks) described above (and/or other visual search tasks).

Each task may have a set of conditions specifying the visual searches for that task. For example, in some embodiments of the single attention visual search task (Task 1), each of the visual search conditions may specify one or more of: colors of the target image and the distracter images, textures of the target image and the distracter images, shapes of the target image and the distracter images, sizes of the target image and the distracter images, orientations of objects shown respectively by the target image and the distracter images, object types shown respectively by the target image and the distracter images, number of distracter images, location of the target image, visual background, and/or visual emphasis of the target image, distracter images, and/or the background, although it should be noted that any other attributes may be used as desired. In some embodiments of the dual attention visual search task (Task 2), each condition may specify any or all of the above, and may also specify the number and type of potential target images, and/or the distinguishing attribute of the potential target images. However, as mentioned above, other attributes may be used as desired.

As mentioned above, in some embodiments, visual emphasis techniques may be used (and varied) to make distinguishing the target images, distracter images, and/or backgrounds more or less difficult. More specifically, as used herein, the term “visual emphasis” generally refers to creation of a combination of a foreground, e.g., target, stimulus and background stimulus, where one or both stimuli have been individually modified to have visual properties specifically chosen to drive cortical neurons strongly and coherently, and whose combination is specifically chosen to further enhance the overall configuration's ability to drive cortical neurons strongly and coherently. In other words, visual emphasis refers to image modification or manipulation that serves to increase the distinguishability of foreground objects, e.g., with respect to the background. Embodiments of the visual emphasis techniques described below are specifically designed to engage these neural mechanisms in a fashion that will robustly engage them and drive positive brain plasticity that leads to faster, more finely tuned processing.

There are several aspects or dimensions along which stimuli may be manipulated to create the emphasis levels. Some dimensions may be described with respect to the objects of interest in a scene, i.e., foreground objects, some with respect to the background of a scene, and some with respect to object/background relations. In some embodiments, the manipulations described herein may occur at two levels; the first level being the a priori level of stimulus selection and artistic design. In other words, the stimuli may be illustrated, animated or selected based on the principles described herein. The second level is the post hoc level of post-processing manipulations. Each manipulation may map to a corresponding image-processing algorithm. Of course, any other means for performing the image processing or manipulations described herein may be used as desired. Note that the appropriate application of visual emphasis manipulations may depend on the visual task. Not all dimensions of emphasis may apply in all cases. Below are described exemplary aspects of visual stimuli that may be manipulated for visual emphasis. It should be noted, however, that the aspects listed are meant to be exemplary only, and are not intended to limit the visual aspects used for visual emphasis to any particular set or type of visual attributes.

The following visual attributes or aspects relate to foreground objects in a scene, i.e., objects of interest.

Spatial frequency: As used herein, and as is well known to those of skill in the imaging arts, “spatial frequency” refers to the level of graphical detail or sharpness of an image. An object that has been manipulated to have a relatively large proportion of high spatial frequency information is said to be sharpened. When the converse manipulation is made, i.e., increasing the relative amount of low spatial frequency information, the object is said to be blurred. Thus, at high levels of visual emphasis, objects may be sharpened, while at low levels, the objects may become somewhat blurred, i.e., the object may become less distinct with respect to the background.

Internal luminance contrast: As used herein, “luminance contrast” refers to the range of luminance or brightness values of pixels in an image. Stimuli with a high degree of overall (e.g., root-mean-squared) internal luminance contrast may drive impaired visual processors more strongly than stimuli with low internal luminance contrast. At the high levels of emphasis, the internal luminance contrast may be made artificially high by increasing the root-mean-squared luminance contrast of the object. At lower levels, luminance contrast may be reduced, e.g., slightly below the nominal baseline level for the object.

Internal chromatic contrast: As used herein, chromatic or color contrast refers to the range of color or hue saturation values of pixels in an image. At high levels of visual emphasis, the internal chromatic contrast may be made artificially high by increasing the root-mean-squared chromatic contrast of the object. At lower levels of visual emphasis, chromatic contrast may be reduced, e.g., to slightly below the nominal baseline level for the object.

The following visual attributes or aspects relate to a background in a scene. Note that since visual emphasis refers to increasing the visual distinction or distinguishability of foreground objects with respect to backgrounds, foreground and background operations for visual emphasis may be conversely related, since increasing a background attribute may have substantially the same distinguishing effect as decreasing the foreground attribute, and vice versa.

Spatial frequency: At high levels of emphasis (for the scene), the low spatial frequency content of the background may be increased relative to the high spatial frequency content (i.e., the background may be blurred), thus making the foreground object(s) appear sharper in contrast. Conversely, as the visual emphasis level is decreased, the blurring of the background may be reduced until, at the final stage, no spatial frequency manipulation is performed.

Internal luminance contrast: At high levels of visual emphasis, the luminance contrast of the background elements may reduced, thereby making the foreground object(s) appear to have more luminance contrast in contrast to the background. At low levels of visual emphasis, the luminance contrast of the background may be increased until, by the final level, the luminance contrast may be set at a naturalistic level, i.e., no modification.

Internal chromatic contrast: At the high levels of emphasis, the chromatic contrast of the background elements may be reduced. At low levels of visual emphasis, the chromatic contrast may be increased until, by the final level, the chromatic contrast is set at a naturalistic level.

Structure: Units in the visual cortex respond most robustly to stimuli presented against plain, artificially unstructured backgrounds. In contrast, stimuli presented against “natural scene” backgrounds generally result in relatively attenuated responses. To create a very salient stimulus that may drive strong visual cortical responses, an unstructured background may be superior. Thus, at the high levels of visual emphasis, the background may be quite plain, i.e., with few structured distracting elements. At low levels of visual emphasis, the background may become more complex, where at the final level of visual emphasis, the background may be a visually rich, complex background environment.

The following visual aspects or attributes relate to the visual relationship between foreground object(s) and background of a scene, and may be set, adjusted, or modified to achieve a specified visual emphasis.

Luminance contrast between object and background: Scenes with high degrees of visual emphasis may involve objects that differ in luminance from their backgrounds. At low levels of emphasis, more typical luminance contrasts for the object(s) and background may be used.

Chromatic contrast between object and background: High degrees of visual emphasis may involve scenes that contain objects that differ in chromaticity (hue or color) from their backgrounds. Low levels of emphasis may involve more typical chromatic contrasts between the objects and their backgrounds.

Motion/dynamic contrast between object and background: One of the most dramatic methods for creating a salient contrast between an object and its background is to effect relative motion or other dynamic contrast (e.g., flashing or flickering) between the object and its background. High degrees of visual emphasis may involve objects that move in a different direction or at a different velocity from background elements, or that flash or flicker with respect to the background, among other dynamic contrast effects. At low levels of emphasis, the objects may be slow moving or static, or may flash or flicker slightly or slowly, among other dynamic contrast effects.

Texture contrast between object and background: Regular patterns may be an important cue to object segregation. When these patterns are consistent and continuous with the background, the effect is known as camouflage. In this camouflaged state, an impaired visual processor may be challenged to represent an object in a salient fashion. Thus, high visual emphasis may be achieved by utilizing a great deal of texture contrast between the object and its background. Similarly, low visual emphasis may be achieved by utilizing a lesser texture contrast between the object and its background.

Object/background opacity: Opacity refers to the degree to which an object or image is opaque or non-transparent. Thus, at high levels of visual emphasis, the object may be presented on or in a (graphical) layer entirely above the background, resulting in a very sharp, high-contrast border between object and background, thus driving strong responses even in an impaired visual processor. At lower levels of emphasis, the object may be given some transparency or presented in a partially occluded fashion behind background elements.

Object size: An object (e.g., a foreground object) in a scene may be made more noticeable or obvious by increasing the size of the object, e.g., with respect to the background, elements in the background, or the visual field. Thus, at high levels of visual emphasis, the object may be larger, while at low levels of visual emphasis, the object may be smaller. Note that in some embodiments, in addition to, or instead of, such size modification of the foreground object(s) in a scene, the background may be modified by decreasing the size of features in the background. Either technique may serve to emphasize or enhance the distinction between the object and the background.

Thus, the various search conditions used in trials over the course of the exercise may include visual emphasis levels in accordance with any of the visual emphasis techniques described above, among others. For example, visual emphasis may be increased to make trials easier, or decreased to make trials more difficult, as desired.

As noted above, there are a variety of ways that the visual search task(s) may be performed over the course of the exercise. For example, in a preferred embodiment, only the single attention task may be performed, where, for example, conditions, e.g., parameters such as eccentricity (of image placement), the number of distracters, and visual emphasis level (among others), may be varied after some number, e.g., 50, of correct trials have been performed.

For example, in a preferred embodiment, the participant may be trained at a selected eccentricity at a time, with a selected number of distracters, and a selected background. It may be important to train in one type of a condition at a time to maximize the training effect. In one exemplary embodiment, the conditions used over the course of the exercise may vary as follows: 9 target/distracter object pairings (e.g., different pairs of bird species); 5 visual emphasis levels (with more similar object/background pairings corresponding to lower levels of visual emphasis); and 3 co-varied groupings of number of distracters and eccentricity (with increasingly large numbers of distracters at greater eccentricities). This schedule results in a total condition set of 135 conditions. Each condition may be performed until some specified number, e.g., 50, of correct responses have been made. However, it should be noted that the above training schedule or regimen is meant to be exemplary only, and is not intended to limit the training schedule or regimen used to any particular approach.

In one embodiment, the repeating may include modifying or adjusting the stimulus intensity of the presented stimuli based on the participant's response. For example, as noted above, in a preferred embodiment, the stimulus intensity may be the presentation time of the stimulus, i.e., the duration of the display of the plurality of images (and possibly the attribute indicator). Thus, in each trial, and in response to the participant's indicated selection of the target image, the stimulus intensity of the visual search may be adjusted for the next trial's visual presentation, i.e., based on whether the participant indicated the target image correctly (or not). The adjustments may generally be made to increase the difficulty of the stimulus when the participant answers correctly (e.g., shortening the presentation time), and to decrease the difficulty of the stimulus when the participant answers incorrectly (e.g., increasing the presentation time). Moreover, the adjustments may be made such that a specified level of performance, i.e., level of success, is approached and substantially maintained during performance of the exercise. For example, based on the participant's responses, the intensity of the visual searches may be adjusted to substantially achieve and maintain a specified success rate, e.g., 85% or 90%, for the participant, although other rates may be used as desired.

In preferred embodiments, the adjustments may be made using a maximum likelihood procedure, such as a QUEST (quick estimation by sequential testing) threshold procedure, or a ZEST (zippy estimation by sequential testing) threshold procedure, described below, such procedures being well-known in the art of stimulus threshold determination. In some embodiments, these adjustments (e.g., using ZEST) may be determined on a per condition basis. In other words, for each condition (used in each task), the visual searches may be presented (and adjusted) in accordance with a maximum likelihood procedure (e.g., ZEST) applied to trials under that condition.

Moreover, in some embodiments, the repeating may also include performing threshold assessments in conjunction with, or as part of, the exercise, e.g., using a maximum likelihood procedure such as ZEST, e.g., a 2-stair ZEST procedure, where the threshold is the value of the stimulus intensity at which the participant achieves a specified level of success, e.g., 0.9, corresponding to a 90% success rate. It should be noted that any other attribute or combination of attributes may be used as desired, the term stimulus intensity being intended to refer to any such adjustable attributes.

Thus, in preferred embodiments, a maximum likelihood procedure, such as a ZEST procedure, may be used to adjust the stimulus intensity of the visual searches during training (e.g., via a single stair ZEST procedure per condition), and may also be used for assessment purposes at periodic stages of the exercise (e.g., via a dual stair ZEST procedure).

In some embodiments, the method may also include performing a plurality of practice trials, i.e., prior to performing the method elements described above. In some embodiments, the participant may be required to show an understanding of the task by achieving a specified level of performance, referred to as a criterion level, on the initial assessment before moving on to the training exercise.

Other features and advantages of the present invention will become apparent upon study of the remaining portions of the specification and drawings.

### BRIEF DESCRIPTION OF THE DRAWINGS

FIG. 1 is a block diagram of a computer system for executing a program according to some embodiments of the present invention;

FIG. 2 is a block diagram of a computer network for executing a program according to some embodiments of the present invention;

FIG. 3 is a high-level flowchart of one embodiment of a method for cognitive training using visual searches, according to one embodiment;

FIGS. 4A and 4B illustrate exemplary screenshots for a single attention visual search task, according to one embodiment;

FIG. 5 illustrates an exemplary screenshot for a dual attention visual search task, according to one embodiment;

FIG. 6 illustrates an exemplary partitioning of the visual field into selectable regions, according to one embodiment;

FIGS. 7 and 8 illustrate screenshots of an exemplary GUI for a single attention visual search task, according to one embodiment; and

FIG. 9 illustrates convergence to a threshold value over a series of trials in an exemplary two-stair ZEST threshold procedure.

### DETAILED DESCRIPTION

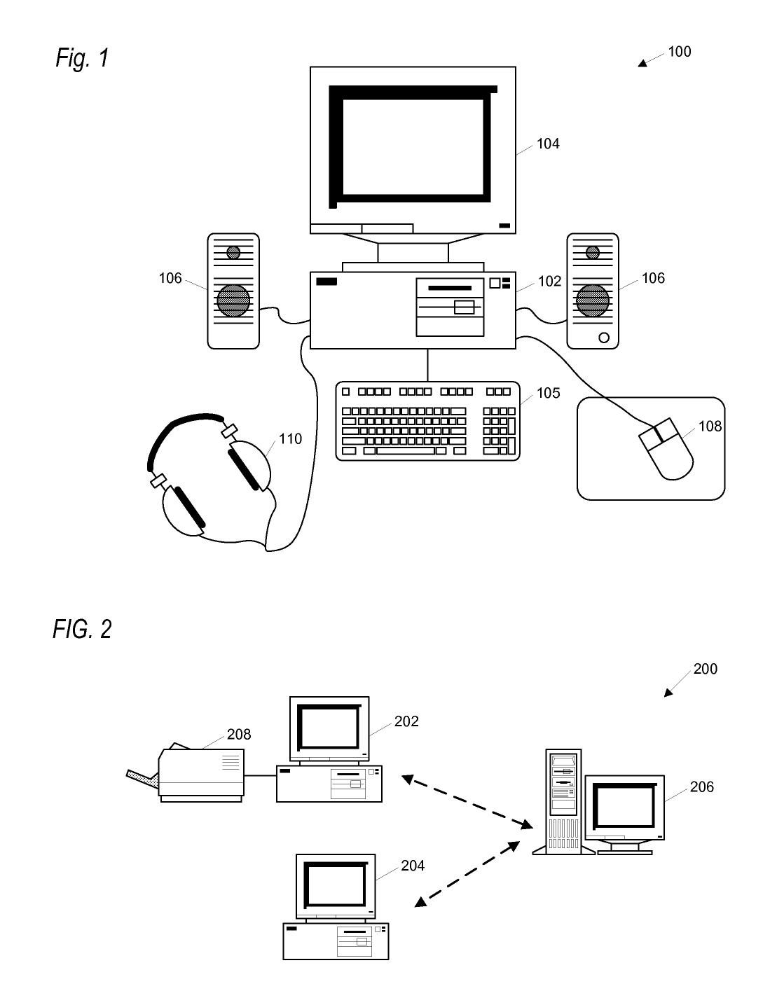

Referring to FIG. 1, a computer system 100 is shown for executing a computer program to train, or retrain an individual according to the present invention to enhance cognition, where the term “cognition” refers to the speed, accuracy and reliability of processing of information, and attention and memory, and where the term “attention” refers to the facilitation of a target and/or suppression of a non-target over a given spatial extent, object-specific area or time window. The computer system 100 contains a computer 102, having a CPU, memory, hard disk and CD ROM drive (not shown), attached to a monitor 104. The monitor 104 provides visual prompting and feedback to the subject during execution of the computer program. Attached to the computer 102 are a keyboard 105, speakers 106, a mouse 108, and headphones 110. In some embodiments, the speakers 106 and the headphones 110 may provide auditory prompting and feedback to the subject during execution of the computer program. The mouse 108 allows the subject to navigate through the computer program, and to select particular responses after visual or auditory prompting by the computer program. The keyboard 105 allows an instructor to enter alphanumeric information about the subject into the computer 102. Although a number of different computer platforms are applicable to the present invention, embodiments of the present invention execute on either IBM compatible computers or Macintosh computers, or similarly configured computing devices such as set top boxes, PDA's, gaming consoles, etc.

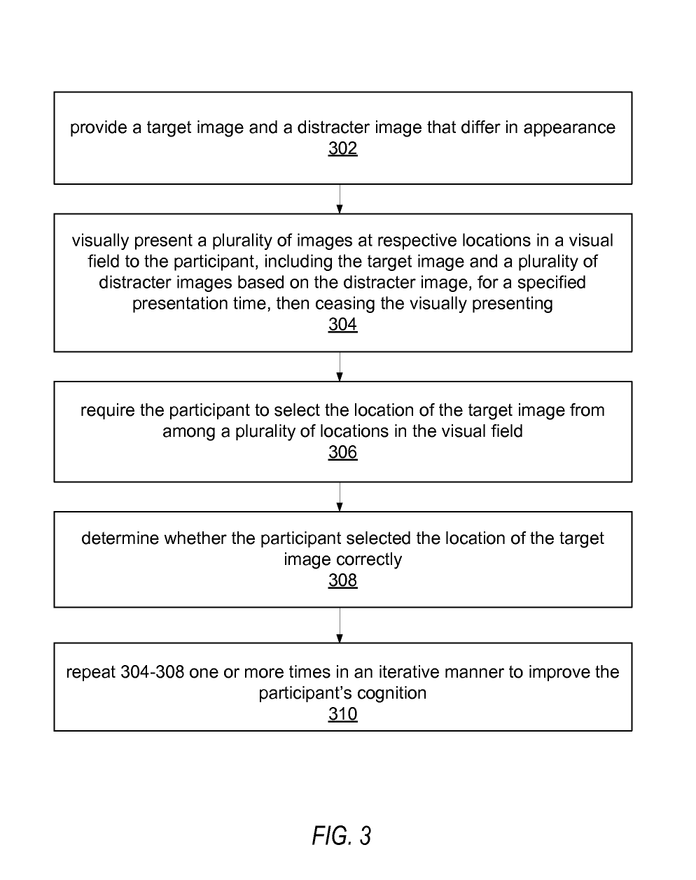

Now referring to FIG. 2, a computer network 200 is shown. The computer network 200 contains computers 202, 204, similar to that described above with reference to FIG. 1, connected to a server 206. The connection between the computers 202, 204 and the server 206 can be made via a local area network (LAN), a wide area network (WAN), or via modem connections, directly or through the Internet. A printer 208 is shown connected to the computer 202 to illustrate that a subject can print out reports associated with the computer program of the present invention. The computer network 200 allows information such as test scores, game statistics, and other subject information to flow from a subject's computer 202, 204 to a server 206. An administrator can review the information and can then download configuration and control information pertaining to a particular subject, back to the subject's computer 202, 204.

Embodiments of the computer-based exercises and tasks described herein may operate to renormalize and improve the participant's cognition, e.g., the ability of the visual nervous system of a participant to search for objects in a visual scene, and the efficiency and capacity of visual attentional processing. In embodiments of the present invention, a target object may be presented together with distracters (other objects) and may vary in the direction and distance from central vision, e.g., the center of the scene, referred to as the fixation point. The training described herein may require focused attention and utilize a reward structure to stimulate neuromodulatory brain processes to optimize learning in a participant, e.g., an aging adult.

Visual Search Exercise

Below are described various embodiments of a cognitive training exercise that utilizes visual searches to improve cognition, e.g., to reverse declines in visual search by incorporating distracters, as well as features to stimulate brain neuromodulatory systems to optimize learning in a participant, e.g., an aging adult. More specifically, embodiments of the exercise may improve the efficiency, capacity and effective spatial extent of visual attentional processing, by training participants to detect targets among distracters. Two exemplary visual search tasks, referred to as Task 1 and Task 2, are presented. In the first task, referred to as a single attention visual search task, there is a single target, while in the second, referred to as a dual attention visual search task, there are two potential targets and the participant is advised which one is the current target by information presented at the fixation point, e.g., at the center of the scene or visual field. It should be noted that in various embodiments, the exercise may include the first task and/or the second task, i.e., may include either task singly, or in combination, as desired.

It should be noted that various embodiments of the visual search tasks described herein, or other visual search tasks, may be used singly or in combination in the exercise. Moreover, as described below, in some embodiments, stimulus threshold assessments may also be performed in conjunction with, or as part of, the exercise, thus facilitating more effective training of the participant's visual processing system.

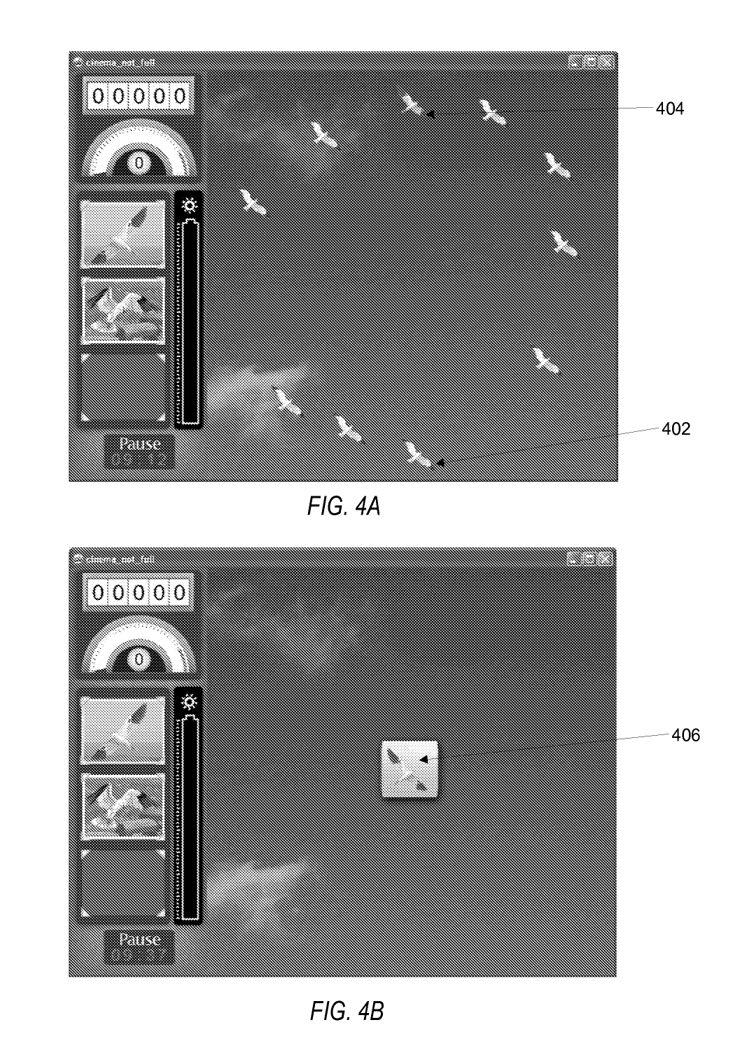

FIG. 3—Flowchart of a Method for Cognitive Training Using Visual Searches

FIG. 3 is a high-level flowchart of one embodiment of a method for cognitive training using visual searches. More specifically, the method utilizes a computing device to present a plurality of images, including a target image and a plurality of distracter images, from which the participant is to select the target image, and to record responses from the participant. It should be noted that in various embodiments, some of the method elements may be performed concurrently, in a different order than shown, or may be omitted. Additional method elements may also be performed as desired. As shown, the method may be performed as follows:

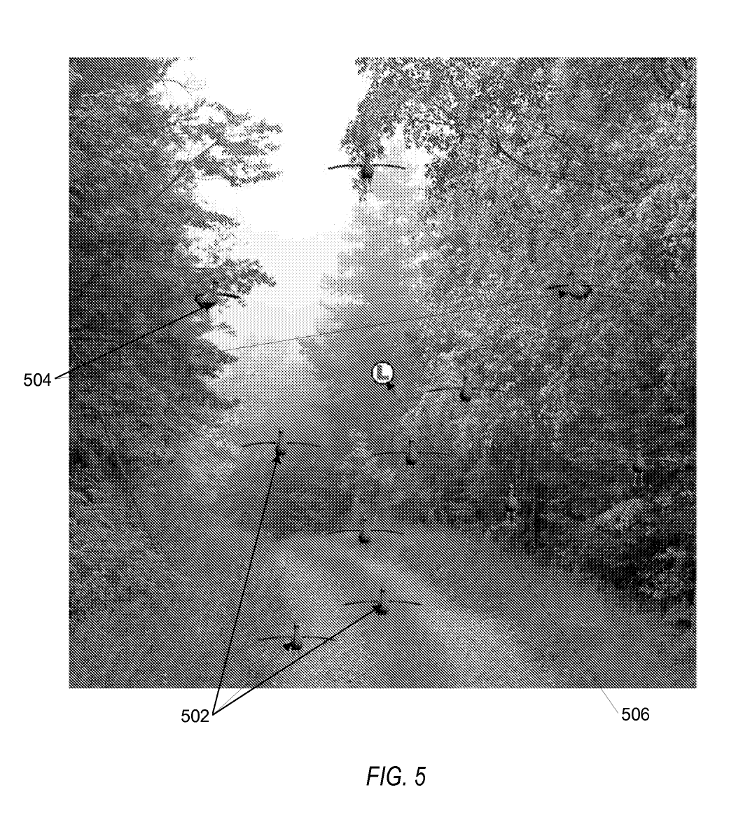

In 302, a target image and a distracter image may be provided, where the target image and the distracter image differ in appearance, and where the target image and distracter image are available for visual presentation to the participant. For example, each image may illustrate an object, such as an animal, with any of various distinguishing attributes, e.g., species, size, object type, object orientation, texture, shape, etc., whereby the target image may be distinguished from the distracter image. In preferred embodiments, the target image may be a first species of bird, and the distracter image may be a second, different, but possibly related, species of bird, e.g., first and second species of gulls, owls, hawks, etc. Exemplary images are described below and illustrated in FIGS. 4A, 4B, 5, and 7-8.

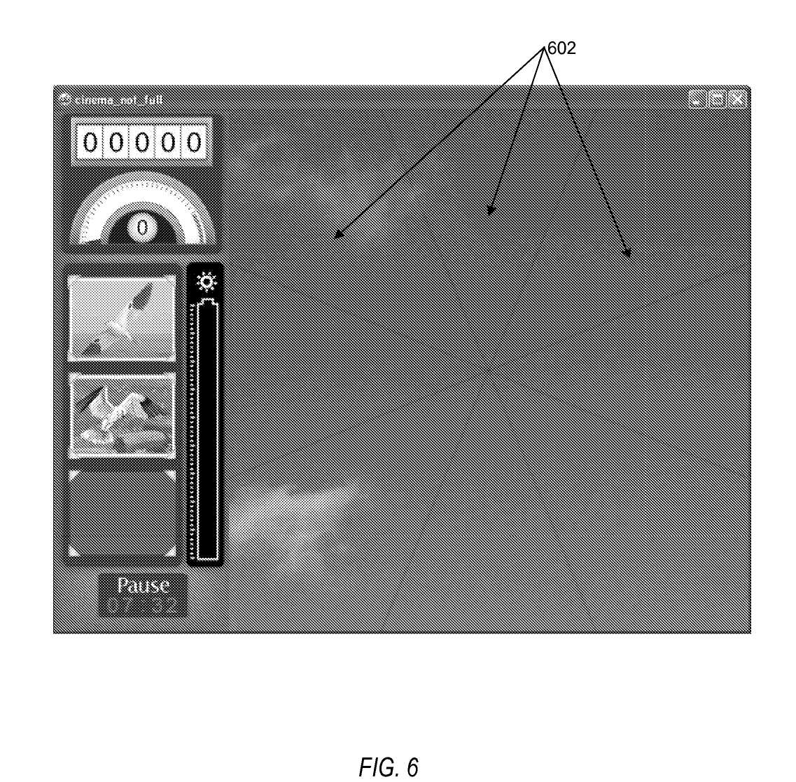

In a single attention visual search task, e.g., Task 1, only the target image and the distracter image may be provided. However, in a dual attention task, e.g., Task 2, in addition to the distracter image, at least two potential target images may be provided, where one of the potential target images is the target image. The potential target images may differ from each other by a specified attribute, e.g., species of bird, or orientation of the object in the image. For example, in a case where there are two potential target images, the two potential target images may be mirror images of one another, as illustrated in FIG. 5, described below, where one potential target image illustrates a bird tilted to the right, and the other potential target image illustrates a bird tilted to the left. Note, however, that all the potential target images are particularly distinct with respect to the distracter images. In other words, the differences between the potential target images and the distracter images are significantly greater than the differences between the potential target images.

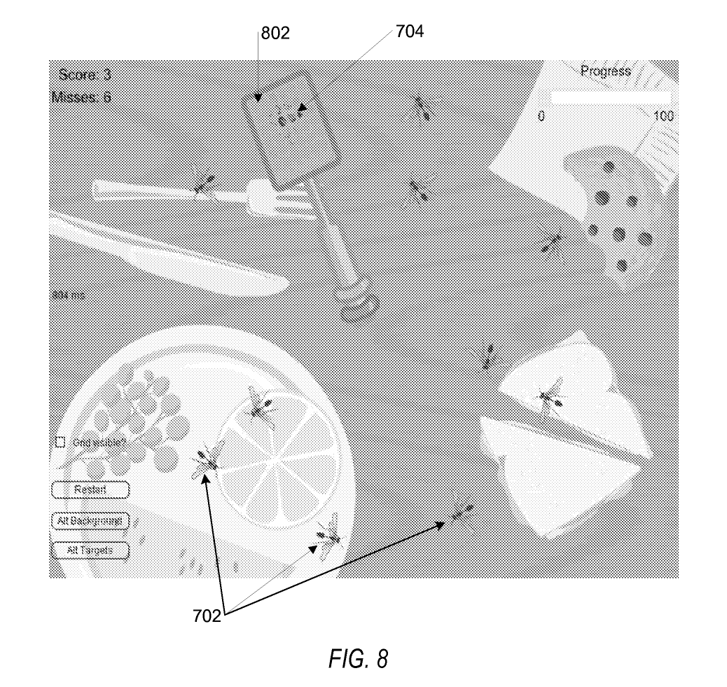

In 304, a plurality of images may be visually presented at respective locations in a visual field to the participant for a specified presentation time, including the target image and a plurality of distracter images based on the distracter image, where at the end of the specified presentation time the visually presenting is ceased. In other words, in addition to the target image, multiple instances of the distracter image of 302 may also be displayed, where these distracter images may be identical (see FIGS. 4A and 5), or in some embodiments may include rotated versions of the original image, i.e., the distracter image of 302 (see, e.g., FIGS. 7 and 8), where the images are displayed for a specified period of time (the presentation time), then removed from the display.

FIGS. 4A and 4B illustrate exemplary screenshots for a single attention visual search task (e.g., Task 1), where, as shown in FIG. 4A, a plurality of distracter images 402 are displayed in a visual field, in this case, identical images of flying birds. In some embodiments, the distracter images may be placed according to some specified scheme, e.g., at some specified eccentricity, according to a perturbed regular grid, e.g., a polar coordinate grid, a 2-dimensional low-discrepancy sequence, etc., as desired, while in other embodiments, the distracter images may be displayed at random positions in the visual field.

As FIG. 4A also shows, in this embodiment, a single target image 404 is displayed among the distracter images 402. Note that in this particular example, the target image 404 illustrates a bird of a different species from the distracter image birds, with different wing coloration from that of the distracter image birds. Note that in the example screenshot of FIG. 4A, the background is somewhat simple, showing a lightly clouded blue sky, and so may not make visual search of the visual field more difficult. However, under different search conditions, the background may be more complex and confusing to the participant, thereby making visual searches more difficult. An example of such a complex background is shown in FIG. 5, described below. It should be noted that in some embodiments, the target and distracter images may be presented against background scenes that make target/distracter distinction more or less difficult based on covariance of image characteristics in the target/distracters and background scene elements, referred to as visual emphasis, described in more detail below. In other words, factors other than the complexity of the background may contribute to the ease or difficulty of distinguishing the target and/or distracters, with respect to the background, such as, for example, the degree of camouflage of the target image and/or the distracters with respect to the background, among others.

In some embodiments, prior to presentation of the target and distracter images, the target image may be displayed, e.g., in the center of the visual field, allowing the participant to familiarize himself/herself with the target. Such a presentation is illustrated in the exemplary screenshot of FIG. 4B, where, as may be seen, an image of the target bird 406 is shown in isolation. In various embodiments, the target image may be displayed for a specified duration, or may remain displayed until dismissed by the participant. In other words, in some embodiments, prior to the visually presenting the plurality of images, the method may include presenting the target image, then removing the target image.

As noted above, in the case of a dual attention visual search task (e.g., Task 2), in addition to the plurality of distracter images, at least two potential target images may be displayed, one of which is the target image, and where the at least two potential target images may differ by a specified attribute. FIG. 5 illustrates an exemplary screenshot for a dual attention visual search task, where, as may be seen, a plurality of distracter images 502 of birds flying straight ahead (out of the screen) is displayed, along with two potential target images 504, one on the left side of the visual field and one on the right side of the visual field. Note that the potential target on the left is shown tilted to the right (is shown flying in a direction to the right of straight ahead), while the potential target on the right side of the screen is shown tilted to the left (is shown flying in a direction to the left of straight ahead). Thus, in this case, the distinguishing specified attribute (of the potential targets) is the left/right orientation of the birds in the potential target images. As mentioned above, one of these potential target images is the target image.

As FIG. 5 also shows, a fixation point 506 is also displayed in the center of the visual field. In some embodiments, an indication of the specified attribute corresponding to a first potential target image of the at least two potential target images may be displayed, where the first potential target image is the target image. In other words, an indication of which of the potential target images is the target image may be displayed. In some embodiments, such as that illustrated in FIG. 5, this indication may be displayed at the center of the visual field, for example, in or on the fixation point. For example, in one embodiment, an “L” or “R” may be displayed indicating which direction the target image bird is tilted. As FIG. 5 shows, in this particular case, an “L” is displayed, and so the potential target image located in the right portion of the visual field is the target image, since the bird in that image is tilted to the left. Note, however, that in other embodiments, other distinguishing attributes and indicators (and means of displaying the indicators) may be used as desired. For example, in one embodiment, the distinguishing attribute between the potential target images may be color, e.g., dark brown vs. light brown, and the indicator may simply be a dot (or other shape) with the same color as the target image.

Although in preferred embodiments, the indicator is displayed at the fixation point (center of the visual field) to facilitate dual attention search (using central and peripheral vision), in other embodiments, the indicator may be displayed in other ways or in other locations, as desired. Note that, as with the single attention task, in the dual attention task, the images (and the indicator) are only displayed for the specified presentation time, after which they images (and indicator) may be removed from the display.

Note the difference between the complex background of FIG. 5 and the simple background of FIG. 4A. As may be seen by comparing the two scenes, the complexity of the background (e.g., in FIG. 5) significantly increases the difficulty of locating and discriminating between the various images.

In preferred embodiments, visually presenting the plurality of image may include visually presenting the plurality of images at a specified stimulus intensity, where, as used herein, the term “stimulus intensity” refers to an adjustable stimulus attribute or adaptive dimension that may be modified to make the search more or less difficult. For example, in a preferred embodiment, the stimulus intensity may be or include the presentation time for the visually presenting of 304. In other words, the stimulus intensity may be the duration of time for which the plurality of images (and in the dual attention tasks, the indicator as well) is displayed. Of course, in other embodiments, other attributes may be used for stimulus intensity as desired.

In some embodiments, the relative difference in appearance between the target and distracters may be manipulated, where the more similar the two are, the more information must be extracted from each image by the participant, thus placing greater demand on the visual attentional system.

In 306, the participant may be required to select a location of the target image from among a plurality of locations in the visual field. In other words, the participant may be required to indicate where in the visual field the target image was displayed. The participant may (attempt to) select the location of the target image in any of a number of ways. For example, in one embodiment, selection of a location of an image may be performed by the participant placing a cursor over the location and clicking a mouse. In a preferred embodiment, the visual field may be partitioned into a plurality of graphically indicated regions, where the location of the target image comprises a specified region of the plurality of regions in the visual field, i.e., the target image is contained in a specified region of the visual field. In preferred embodiments, the selection grid isn't displayed until the images are removed from the visual field.

Thus, in some embodiments, selection of a location of an image is performed by the participant placing a cursor over (or in) a region that contained the image and clicking a mouse.

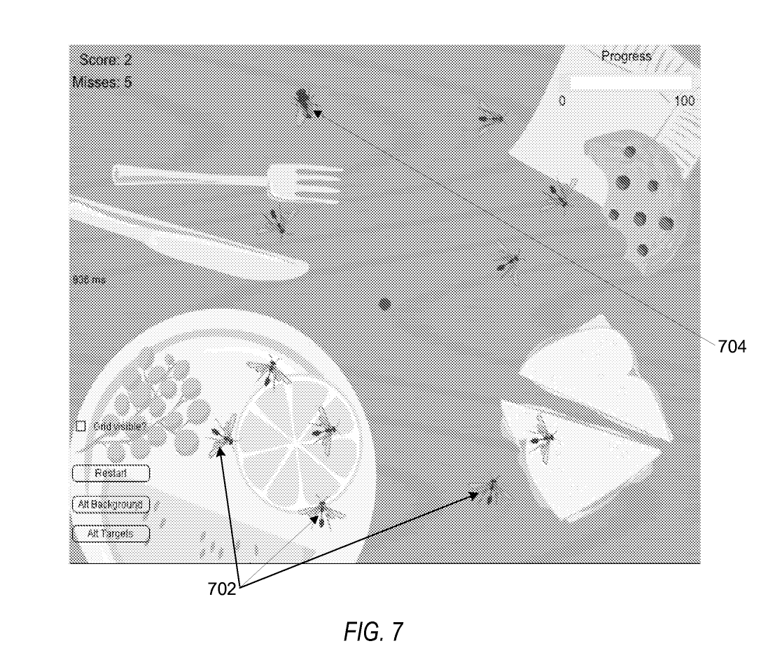

FIG. 6 illustrates such an exemplary partitioning of the visual field into selectable regions, such as regions 602. As may be seen, in this example the visual field is divided into 8 regions, all converging at the center (fixation point) of the field. It should be noted that in some embodiments, each image's location may specified by its respective region, and each location may also have an associated eccentricity, where an image's eccentricity refers to the angular distance from the fixation point to the image given a specified viewing distance from the screen. For example, exemplary eccentricity values may include 10, 15 and 20 degrees (or equivalents), at a viewing distance of 35 cm, although other values may be used as desired.

Note that in this particular embodiment (of FIG. 6), the radial distance of an image from the fixation point is not a factor in indicating the image's location (since each region extends from the center to the edge of the visual field); however, the placement or location of that image may depend (at least partially) on its eccentricity, where, for example, an image's eccentricity value may make the visual search by the participant more or less difficult. For example, in some embodiments of the dual attention visual search task, potential target images with high eccentricities may be more difficult to process, given that the participant's attention is divided between the indication (of a distinguishing attribute of the target image) at the fixation point at the center of the visual field, and the potential target images, which, due to their eccentricities, are located near the edge of the visual field. In some embodiments, the regions may be defined by both angular partitions (as shown in FIG. 6), and radial partitions (not shown), e.g., demarcated by concentric circles around the fixation point, reflecting different eccentricities.

In some embodiments, there may be multiple presentations of target/distracter sets shown (in 304) before the participant makes a response. For example, 3 sets of target/distracter sets (scenes) may be visually presented, after which the participant may be required to respond, indicating the order of locations (selectable regions) where the targets appeared in each set. In other words, a sequence of target/distracter/background scenes may be presented, after which the participant may be required to indicate the corresponding sequence of target image locations (regions).

Note that while in the single attention visual search task, the participant is required to select the location (or sequence of locations) of the target image (or target images) from among a plurality of locations in the visual field, where the displayed images include the target image and a plurality of distracter images, in embodiments of the dual attention visual search task, e.g., where there are at least two potential target images displayed, a first of these potential target images being the target image itself, as well as an indication of the distinguishing attribute of the target image (with respect to the other potential target image(s)), the participant may be required to select the location of the first potential target image from among the plurality of locations in the visual field, including selecting a location of the first potential target image from among the locations of the at least two potential target images based on the visually presented indication.

In 308, a determination may be made as to whether the participant selected the location of the target image (or sequence of target image locations) correctly. In some embodiments, whether the participant correctly selected the location of the target image (or not) may be recorded. In some embodiments, an indication, e.g., a graphical or audible indication, may be provided to the participant indicating the correctness or incorrectness of the participant's response. For example, a “ding” or a “thunk” may be played to indicate correctness or incorrectness, respectively, and/or points may be awarded (in the case of a correct response). Of course, any other type of indication may be used as desired. The above visually presenting, requiring, and determining, may compose a trial in the exercise or task.

In some embodiments, the participant may perform the exercise or tasks via a graphical user interface (GUI). The GUI may include a stimulus presentation area where the images of 304 may be presented to the participant, such as the exemplary visual fields of FIGS. 4A, 5, and 6, as well as means for receiving input from the participant, e.g., the selectable regions described above. Moreover, in some embodiments, additional GUI elements may be provided, e.g., for indicating various aspects of the participant's progress or status with respect to the exercise or task. For example, the GUI may include one or more of: a score indicator that indicates the participant's current score in the task or exercise, a time remaining indicator that provides an indication of how much time remains in the current task, session, or exercise, a threshold field that displays stimulus threshold information, such as the current threshold value and a best threshold value, where a threshold indicates or is the value of an adjustable stimulus attribute or adaptive dimension, referred to as the stimulus intensity, that results in a specified performance level, i.e., success rate, for the participant, as will be explained below in more detail. In various embodiments, the GUI may also include additional indicators, such as, for example, a bonus meter (or equivalent), which may indicate the number of correct responses in a row, and may flash, play music, and/or award bonus points, when some specified number, e.g., 5, in a row is attained. It should be noted that the GUIs described above are meant to be exemplary only, and that other GUIs are envisioned.

For example, FIGS. 7 and 8 illustrate an exemplary embodiment of a GUI for a single attention visual search task in which the distracter images are images of small flying insects, and the target image is that of a large fly 704. As shown, this GUI includes a display area, i.e., the visual field wherein the images are displayed (and in some embodiments, then removed), as well as various GUI elements for displaying progress in the exercise or task or interacting with the GUI. For example, in the upper left corner of the display are displayed a score indicator, and an indicator that displays how many misses have occurred. In the upper right corner of the display, a progress bar is shown that indicates the participant's progress in the current exercise or task. As FIG. 7 also shows, in this embodiment, various controls are displayed in the bottom left corner of the display, including a restart button, an alternate background button, whereby the participant may switch to a different background for the images, and an alternative targets button, whereby the participant may switch the types of targets presented in the exercise or task. However, it should be noted that these particular GUI elements are meant to be exemplary only, and are not intended to limit the GUIs contemplated to any particular form, function, or appearance. In the embodiment of FIGS. 7 and 8, the participant may (attempt to) select the target image 704 by “swatting” the area of the scene where the fly appeared, i.e., using a fly swatter-shaped cursor 802, as shown in FIG. 8. In one embodiment, once the swatter is used the insects may reappear so that the participant can see if the response is correct. Thus, in this embodiment, rather than selecting specified regions within which images may be located, the participant may select the specific location of the target image (i.e., where the target image was temporarily displayed).

In 310, the visually presenting, requiring, and determining of 304, 306, and 308 may be repeated one or more times in an iterative manner, to improve the participant's cognition, e.g., efficiency, capacity and effective spatial extent of visual attentional processing, e.g., visual processing skills.

In other words, a plurality of trials may be performed in the exercise (with respect to either or both tasks), where various search fields and images are visually presented to the participant, as described above. For example, the repetitions may be performed over a plurality of sessions, e.g., over days, weeks, or even months, e.g., for a specified number of times per day, and for a specified number of days. In some embodiments, at the end of each session, the participant's score and thresholds for the session may be shown and may be compared to the best performance.

Such repeating preferably includes trials performed under a variety of specified search conditions, wherein each visual search condition specifies one or more attributes of the plurality of images or their presentation, e.g., with visual searches covering a range of search attributes. Such conditions may include baseline conditions, used before, after, and at specified points during, the exercise to assess the participant's performance (described further below), and non-baseline or training conditions, used for the actual training during the exercise. Thus, blocks of stimuli may contain particular conditions affecting the difficulty of the searches.

In some embodiments, trials in the exercise may be directed to a single visual search task, e.g., to a single attention visual search task, or a dual attention visual search task; however, as mentioned above, in preferred embodiments, the repeating may include performing trials in each of the visual search tasks (e.g., the single and dual attention visual search tasks) described above (and/or other visual search tasks).

Each task may have a set of conditions specifying the visual searches for that task. For example, in some embodiments of the single attention visual search task (Task 1), each of the visual search conditions may specify one or more of: colors of the target image and the distracter images, textures of the target image and the distracter images, shapes of the target image and the distracter images, sizes of the target image and the distracter images, orientations of objects shown respectively by the target image and the distracter images, object types shown respectively by the target image and the distracter images, number of distracter images, location of the target image, visual background, and/or visual emphasis of the target image, distracter images, and/or the background, although it should be noted that any other attributes may be used as desired. In some embodiments of the dual attention visual search task (Task 2), each condition may specify any or all of the above, and may also specify the number and type of potential target images, and/or the distinguishing attribute of the potential target images (e.g., object orientation-see FIG. 5). However, as mentioned above, other attributes may be used as desired.

Visual Emphasis

As mentioned above, in some embodiments, visual emphasis techniques may be used (and varied) to make distinguishing the target images, distracter images, and/or backgrounds more or less difficult.

Age-related changes cause neural systems to respond more slowly and less robustly to preferred visual stimuli than they once did. In large part these changes are due to plastic reorganization of network properties that are locally adaptive, resulting in relatively unimpaired performance under a limited and specific range of environmental stimulation encountered by the aging organism. However, these changes are generally globally maladaptive, with simple task performance, such as central foveal detection, being relatively maintained at the cost of more complex and challenging visual tasks, such as peripheral object identification.

In order to renormalize visual processing in a global sense, the efficiency of mechanisms involved in complex, speeded task performance must be improved. In order to drive positive plasticity in these systems to improve their speed, accuracy, and overall function, slow and poorly tuned neurons and neural networks need to be strongly and coherently activated in the initial phases of training in a fashion that will engage these plastic mechanisms in a robust manner. In the context of adaptive visual training, i.e., training with visual stimuli, this effect can be elicited by initially strongly “emphasizing” the visual scene. As used herein, the term “visual emphasis” generally refers to creation of a combination of a target stimulus and background stimulus, where one or both stimuli have been individually modified to have visual properties specifically chosen to drive cortical neurons strongly and coherently, and whose combination is specifically chosen to further enhance the overall configuration's ability to drive cortical neurons strongly and coherently. In other words, visual emphasis refers to image modification or manipulation that serves to increase the distinguishability of foreground objects, e.g., with respect to the background. Embodiments of the visual emphasis techniques described below are specifically designed to engage these neural mechanisms in a fashion that will robustly engage them and drive positive brain plasticity that leads to faster, more finely tuned processing.

There are several aspects or dimensions along which stimuli may be manipulated to create the emphasis levels. Some dimensions may be described with respect to the objects of interest in a scene, i.e., foreground objects, some with respect to the background of a scene, and some with respect to object/background relations. In some embodiments, the manipulations described herein may occur at two levels; the first level being the a priori level of stimulus selection and artistic design. In other words, the stimuli may be illustrated, animated or selected based on the principles described herein. The second level is the post hoc level of post-processing manipulations. Each manipulation may map to a corresponding image-processing algorithm. Commercially available programs such as Photoshop®, provided by Adobe Systems Incorporated, implement many of these algorithms. Moreover, many of these algorithms may be implemented using image processing packages such as those available in Matlab®, provided by The MathWorks. Of course, any other means for performing the image processing or manipulations described herein may be used as desired. Note that the appropriate application of visual emphasis manipulations may depend on the visual task. Not all dimensions of emphasis may apply in all cases.

Below are described exemplary aspects of visual stimuli that may be manipulated for visual emphasis. It should be noted, however, that the aspects listed are meant to be exemplary only, and are not intended to limit the visual aspects used for visual emphasis to any particular set or type of visual attributes.

Foreground Objects

The following visual attributes or aspects relate to foreground objects in a scene, i.e., objects of interest.

Spatial frequency: As used herein, and as is well known to those of skill in the imaging arts, “spatial frequency” refers to the level of graphical detail or sharpness of an image. An object that has been manipulated to have a relatively large proportion of high spatial frequency information is said to be sharpened. When the converse manipulation is made, i.e., increasing the relative amount of low spatial frequency information, the object is said to be blurred. Thus, at high levels of visual emphasis, objects may be sharpened. The increased high-spatial frequency information may strongly activate neural mechanisms in the cortex that are under-stimulated, while creating a salient contrast from the background. In other words, the object may become more distinct with respect to the background. Conversely, as the visual emphasis is decreased to low levels, the objects may become somewhat blurred, creating a more photo-realistic effect by simulating natural atmospheric scattering and optical defocus, and reducing the spatial frequency gradient cue to object/background segregation. In other words, the object may become less distinct with respect to the background.

Internal luminance contrast: As used herein, “luminance contrast” refers to the range of luminance or brightness values of pixels in an image. Stimuli with a high degree of overall (e.g., root-mean-squared) internal luminance contrast may drive impaired visual processors more strongly than stimuli with low internal luminance contrast. Neural mechanisms that are impaired or poorly tuned may be activated by high luminance contrast stimuli to the same degree that normally functioning neural mechanisms are activated by low to medium luminance contrast stimuli. This strong engagement may drive differential responses in mechanisms tuned to the relevant stimulus dimension in the object. At the high levels of emphasis, the internal luminance contrast may be made artificially high by increasing the root-mean-squared luminance contrast of the object. At lower levels, luminance contrast may be reduced, e.g., slightly below the nominal baseline level for the object.

Internal chromatic contrast: As used herein, chromatic or color contrast refers to the range of color or hue saturation values of pixels in an image. Visual cortical neurons are tuned to chromatic contrast as well as luminance contrast, and so increasing the chromatic contrast internal to the object may engage a partially overlapping distribution of neural mechanisms to those preferentially affected by increasing internal luminance contrast. Moreover, the effect of increasing both luminance contrast (see above) and chromatic contrast simultaneously is synergistic. At high levels of visual emphasis, the internal chromatic contrast may be made artificially high by increasing the root-mean-squared chromatic contrast of the object. At lower levels of visual emphasis, chromatic contrast may be reduced, e.g., to slightly below the nominal baseline level for the object.

Background

The following visual attributes or aspects relate to a background in a scene. Note that since visual emphasis refers to increasing the visual distinction or distinguishability of foreground objects with respect to backgrounds, foreground and background operations for visual emphasis may be conversely related, since increasing a background attribute may have substantially the same distinguishing effect as decreasing the foreground attribute, and vice versa.

Spatial frequency: At high levels of emphasis (for the scene), the low spatial frequency content of the background may be increased relative to the high spatial frequency content (i.e., the background may be blurred), thus making the foreground object(s) appear sharper in contrast. Conversely, as the visual emphasis level is decreased, the blurring of the background may be reduced until, at the final stage, no spatial frequency manipulation is performed.

Internal luminance contrast: At high levels of visual emphasis, the luminance contrast of the background elements may reduced, thereby making the foreground object(s) appear to have more luminance contrast in contrast to the background. At low levels of visual emphasis, the luminance contrast of the background may be increased until, by the final level, the luminance contrast may be set at a naturalistic level, i.e., no modification.

Internal chromatic contrast: At the high levels of emphasis, the chromatic contrast of the background elements may be reduced. At low levels of visual emphasis, the chromatic contrast may be increased until, by the final level, the chromatic contrast is set at a naturalistic level.

Structure: Units in the visual cortex respond most robustly to stimuli presented against plain, artificially unstructured backgrounds. In contrast, stimuli presented against “natural scene” backgrounds generally result in relatively attenuated responses. To create a very salient stimulus that may drive strong visual cortical responses, an unstructured background may be superior. Thus, at the high levels of visual emphasis, the background may be quite plain, i.e., with few structured distracting elements. At low levels of visual emphasis, the background may become more complex, where at the final level of visual emphasis, the background may be a visually rich, complex background environment.

Object-Background Relation

The following visual aspects or attributes relate to the visual relationship between foreground object(s) and background of a scene, and may be set, adjusted, or modified to achieve a specified visual emphasis.

Luminance contrast between object and background: An impaired visual processor may respond most robustly to an object stimulus that is quite distinct from its background, e.g., along the most basic visual dimensions. A fundamental or primary visual dimension is the light intensity or luminance dimension. Scenes with high degrees of visual emphasis may thus involve objects that differ in luminance from their backgrounds. At low levels of emphasis, more typical luminance contrasts for the object(s) and background may be used.

Chromatic contrast between object and background: Another fundamental visual dimension is the chromatic, i.e., color or hue contrast dimension. High degrees of visual emphasis may involve scenes that contain objects that differ in chromaticity (hue or color) from their backgrounds. Low levels of emphasis may involve more typical chromatic contrasts between the objects and their backgrounds.

Motion/dynamic contrast between object and background: One of the most dramatic methods for creating a salient contrast between an object and its background is to effect relative motion or other dynamic contrast (e.g., flashing or flickering) between the object and its background. High degrees of visual emphasis may involve objects that move in a different direction or at a different velocity from background elements, or that flash or flicker with respect to the background, among other dynamic contrast effects. At low levels of emphasis, the objects may be slow moving or static, or may flash or flicker slightly or slowly, among other dynamic contrast effects.

Texture contrast between object and background: Regular patterns may be an important cue to object segregation. When these patterns are consistent and continuous with the background, the effect is known as camouflage. In this camouflaged state, an impaired visual processor may be challenged to represent an object in a salient fashion. Thus, high visual emphasis may be achieved by utilizing a great deal of texture contrast between the object and its background. Similarly, low visual emphasis may be achieved by utilizing a lesser texture contrast between the object and its background.

Object/background opacity: Opacity refers to the degree to which an object or image is opaque or non-transparent. Thus, at high levels of visual emphasis, the object may be presented on or in a (graphical) layer entirely above the background, resulting in a very sharp, high-contrast border between object and background, thus driving strong responses even in an impaired visual processor. At lower levels of emphasis, the object may be given some transparency or presented in a partially occluded fashion behind background elements.

Object size: An object (e.g., a foreground object) in a scene may be made more noticeable or obvious by increasing the size of the object, e.g., with respect to the background, elements in the background, or the visual field. Thus, at high levels of visual emphasis, the object may be larger, while at low levels of visual emphasis, the object may be smaller. Note that in some embodiments, in addition to, or instead of, such size modification of the foreground object(s) in a scene, the background may be modified by decreasing the size of features in the background. In other words, the background, or features of the background, may be shrunk (or magnified), thereby increasing (or decreasing) the relative size of the foreground object(s) with respect to the background (features). Thus, for example, in an abstract scene where a square (foreground object) is displayed in a background of many circular dots, the dots may be reduced or magnified in size to change the relative size of the square. Either technique may serve to emphasize or enhance the distinction between the object and the background.

Thus, the various search conditions used in trials over the course of the exercise may include visual emphasis levels in accordance with any of the visual emphasis techniques described above, among others. For example, visual emphasis may be increased to make trials easier, or decreased to make trials more difficult, as desired.

As noted above, there are a variety of ways that the visual search task(s) may be performed over the course of the exercise. For example, in a preferred embodiment, only the single attention task may be performed, where, for example, conditions, e.g., parameters such as eccentricity (of image placement), the number of distracters, and visual emphasis level (among others), may be varied after some number, e.g., 50, of correct trials have been performed.

For example, in a preferred embodiment, the participant may be trained at a selected eccentricity at a time, with a selected number of distracters, and a selected background. It may be important to train in one type of a condition at a time to maximize the training effect. In one exemplary embodiment, the conditions used over the course of the exercise may vary as follows: 9 target/distracter object pairings (e.g., different pairs of bird species); 5 visual emphasis levels (with more similar object/background pairings corresponding to lower levels of visual emphasis); and 3 co-varied groupings of number of distracters and eccentricity (with increasingly large numbers of distracters at greater eccentricities). This schedule results in a total condition set of 135 conditions. Each condition may be performed until some specified number, e.g., 50, of correct responses have been made. However, it should be noted that the above training schedule or regimen is meant to be exemplary only, and is not intended to limit the training schedule or regimen used to any particular approach.

In one exemplary training schedule or regimen utilizing both visual search tasks, on first alternate sessions, trials under a first number of conditions may be performed for the single attention search task, and under a second number of conditions for the dual attention search task, and on second alternate sessions, trials under the second number of conditions may be performed for the single attention search task, and under the first number of conditions for the dual attention search task, where the first alternate sessions and the second alternate sessions are interleaved, e.g., the respective number of conditions used per task may alternate on a per session basis. Thus, in an embodiment where the repeating is performed over a 40 day training period, and where the participant is trained on 3 conditions per session (e.g., 3 conditions per day), e.g., for a total of 15 minutes, of the 3 conditions, 1 may be from one search type, and 2 may be from the other search type, and this may alternate with each training session.

In another exemplary schedule, the type of search may be consistent for that day (either single attention searches or dual attention searches) and may alternate each day. In other words, on a particular day, the participant may be presented trials under three conditions for one type of search only (either single attention or dual attention). The next day, the participant may be presented with trials under conditions for the other type of search. Thus, for example, a block sequence may be trained on every other day for a total of 5 days. This approach may maximize the training effect of the exercise.

As noted above, the participant may be trained at a selected eccentricity at a time, with a selected number of distracters, and a selected background. It may be important to train in one type of a condition at a time to maximize the training effect. In one embodiment, the particular task performed may also be considered a condition. In one exemplary embodiments, the conditions used over the course of the exercise may vary as follows: 2 task types (single versus dual attention); 4 target/distracter horizontal rotation differences (90, 67.5, 45, 22.5 degrees); 3 eccentricities; 2 background levels; and 3 sets of distracter numbers (i.e., numbers of distracter images). This results in a total condition set of 144 conditions. Thus, at 5 minutes per condition, the exercise may require a total of 12 hours of training. However, it should be noted that the above training schedule or regimen is meant to be exemplary only, and is not intended to limit the training schedule or regimen used to any particular approach. Thus, in some embodiments, the exercise may include performing multiple tasks, e.g., Task 1 and Task 2, using visual searches.

In one embodiment, the repeating may include modifying or adjusting the stimulus intensity of the presented stimuli based on the participant's response. For example, as noted above, in a preferred embodiment, the stimulus intensity may be the presentation time of the stimulus, i.e., the duration of the display of the plurality of images (and possibly the attribute indicator). Thus, in each trial, and in response to the participant's indicated selection of the target image, the stimulus intensity of the visual search may be adjusted for the next trial's visual presentation, i.e., based on whether the participant indicated the target image correctly (or not). The adjustments may generally be made to increase the difficulty of the stimulus when the participant answers correctly (e.g., shortening the presentation time), and to decrease the difficulty of the stimulus when the participant answers incorrectly (e.g., increasing the presentation time). Moreover, the adjustments may be made such that a specified level of performance, i.e., level of success, is approached and substantially maintained during performance of the exercise. For example, based on the participant's responses, the intensity of the visual searches may be adjusted to substantially achieve and maintain a specified success rate, e.g., 85% or 90%, for the participant, although other rates may be used as desired.

In preferred embodiments, the adjustments may be made using a maximum likelihood procedure, such as a QUEST (quick estimation by sequential testing) threshold procedure, or a ZEST (zippy estimation by sequential testing) threshold procedure, described below, such procedures being well-known in the art of stimulus threshold determination. In some embodiments, these adjustments (e.g., using ZEST) may be determined on a per condition basis. In other words, for each condition (used in each task), the visual searches may be presented (and adjusted) in accordance with a maximum likelihood procedure (e.g., ZEST) applied to trials under that condition.

Moreover, as described below, the repeating may also include performing threshold assessments in conjunction with, or as part of, the exercise. A description of threshold determination/assessment is provided below.

Threshold Determination/Assessment

As indicated above, stimulus intensity is an adjustable attribute of a presented stimulus whereby the task or a trial in the task may be made more or less difficult. For example, in one embodiment, the stimulus intensity may be the duration of the stimulus presentation, i.e., the presentation time, although other attributes of the stimulus may be used as desired. The threshold is the value of the stimulus intensity at which the participant achieves a specified level of success, e.g., 0.9, corresponding to a 90% success rate. It should be noted that any other attribute or combination of attributes may be used as desired, the term stimulus intensity being intended to refer to any such adjustable attributes.

Exercise based assessments (i.e., threshold determination) are designed to assess a participant's threshold with respect to stimuli on a given exercise, and can be used to adjust stimulus presentation to (substantially) achieve and maintain a desired success rate for the participant, e.g., with respect to a particular exercise, task, or condition. As will be described below, such threshold determination may also be used to assess or determine a pre-training threshold that can then be used to calibrate the program to an individual's capabilities on various exercises, as well as serve as a baseline measure for assessing the participant's performance periodically during an exercise. Such assessment may also serve as a baseline measure to which post-training thresholds can be compared. Comparison of pre-training to post-training thresholds may be used to determine the gains made as a function of training with the cognition enhancement exercise or tasks described herein.

As noted above, there are various approaches whereby such thresholds may be assessed or determined, such as, for example, the well known QUEST (Quick Estimation by Sequential Testing) threshold method, which is an adaptive psychometric procedure for use in psychophysical experiments, or a related method, referred to as the ZEST (Zippy Estimation by Sequential Testing) procedure or method, among others, although it should be noted that such methods have not heretofore been utilized in cognition enhancement training exercises using visual stimuli, as described herein.

The ZEST procedure is a maximum-likelihood strategy to estimate a subject's threshold in a psychophysical experiment based on a psychometric function that describes the probability a stimulus is detected as a function of the stimulus intensity. For example, consider a cumulative Gaussian psychometric function, F(x−T), for a 4-alternative-forced-choice (afc) task with a 5% lapsing rate, with proportion correct (ranging from 0-1) plotted against intensity of the stimulus (ranging from 0-5). As used herein, the term intensity (with respect to stimuli) refers to the value of the adaptive dimension variable being presented to the participant at any particular trial in a particular exercise. In other words, the intensity value is that parameter regarding the exercise stimuli that may be adjusted or adapted, e.g., to make a trial more or less difficult. For example, in preferred embodiments of the visual search exercise, the intensity value is the search duration or presentation time (e.g., in milliseconds). The threshold is defined to be the mean of the Gaussian distribution for a specified success rate—e.g., a value yielding some specified success rate, e.g., 60%.

The method may make some assumptions about the psychophysics:

1. The psychometric function has the same shape, except a shift along the stimulus intensity axis to indicate different threshold value.

2. The threshold value does not change from trial to trial.

3. Individual trials are statistically independent.

The primary idea of the ZEST procedure is as follows: given a prior probability density function (P.D.F.) centered around the best threshold guess, x, this P.D.F. is adjusted after each trial by one of two likelihood functions, which are the probability functions that the subject will respond “yes” or “no” to the stimulus at intensity as a function of threshold. Since the psychometric function has a constant shape and is of the form F(x−T), fixing the intensity x and treating threshold T as the independent variable, the “yes” likelihood, p=F(−(T−x)), is thus the mirror image of the psychometric function about the threshold, and the “no” likelihood function is then simply 1−p.

The P.D.F. is updated using Bayes' rule, where the posterior P.D.F. is obtained by multiplying the prior P.D.F. by the likelihood function corresponding to the subject's response to the trial's stimulus intensity. The mean of the updated (or posterior) P.D.F. is then used as the new threshold estimate and the test is repeated with the new estimate until the posterior P.D.F. satisfies a confidence interval criteria (e.g. standard deviation of posterior P.D.F.<predetermined value) or a maximum number of trials is reached.

In one example of the ZEST procedure, a single trial of a 4-afc experiment is performed, with x=2.5 (intensity) as the initial threshold guess. If the subject responds correctly, the next trial is placed at the mean of the corresponding posterior P.D.F., ˜x=2.3; if the response is incorrect, the next trial is placed at the mean of the corresponding P.D.F., ˜x=2.65.

Thus, in some embodiments, a single stair ZEST procedure such as that described above may be used to adjust the intensity of the stimuli for the visual searches during training. In contrast, in some embodiments, particularly with respect to the periodic assessments during the exercise (as opposed to the “per response” stimulus adjustment) a 2-stair ZEST procedure may be employed, where two independent tracks with starting values, preferably encompassing the true threshold, each running its own ZEST procedure, are randomly interleaved in the threshold seeking procedure. In addition to their individual termination criterion, the difference between the two stairs may also be required to be within a specified range, e.g., the two stairs may be constrained to be a predetermined distance apart. An exemplary implementation of this approach is described below with respect to the visual search threshold assessment.

As used herein, the parameters required for ZEST may include the mean of the prior P.D.F. (threshold estimate), the standard deviation of the prior P.D.F. (spread of threshold distribution), the standard deviation of the cumulative Gaussian distribution (slope of psychometric function), the maximum number of trials to run, and a confidence level and interval. Additionally, in one embodiment, the trial-by-trial data saved for analysis may include: the track used, the stimulus intensity presented, the subject's response, the mean of posterior P.D.F., and the standard deviation of the posterior P.D.F., as well as any other data deemed necessary or useful in determining and/or assessing the participant's threshold.

Thus, in preferred embodiments, a maximum likelihood procedure, such as a ZEST procedure, may be used to adjust the stimulus intensity of the visual searches during training (e.g., via a single stair ZEST procedure per condition), and may also be used for assessment purposes at periodic stages of the exercise (e.g., via a dual stair ZEST procedure, describe below). In one embodiment, such assessment may occur at specified points during the exercise, e.g., at 0% (i.e., prior to beginning), 25%, 50%, 75%, and 100% (i.e., after completion of the exercise) of the exercise. Thus, for example, in a 40-day exercise schedule, these assessments, which may be referred to as baseline measurements, may be made on days before and after training, and after 10, 20, and 30 days of training, to gauge improvements over the training time.

In another embodiment, the participant may be prompted or instructed to take an assessment on the first training day, and may be offered the opportunity to take an assessment at any other point during the training. For example, the participant may be prompted or advised to take an assessment at certain points during the training when the participant's performance during training reaches a certain level, possibly weighted by the number of training trials that have been performed.

An example of an assessment is now described.

In one embodiment, a primary purpose of the visual search threshold assessment is to determine the smallest duration of stimulus presentation time in a visual search task that a person can respond correctly to above a statistical threshold, although it should be noted that other attributes may be used as stimulus intensity as desired, duration being but an exemplary stimulus intensity. The visual search assessment may be similar to the visual search exercise with respect to visual presentation, where the differences between the assessment and the exercise lie (at least primarily) in the movement or progression through the task and the data that are obtained from this movement for the assessment. The procedure is designed to obtain a threshold, which is a statistical rather than an exact quantity. In one embodiment, for the purposes of this exercise, the threshold may be defined as the smallest duration of stimulus presentation time (in milliseconds) for visual search at which the participant will respond correctly a specified percentage, e.g., 69%, 90%, etc., of all trials for the task. In a preferred embodiment, being a computer based task, the visual search assessment may use the ZEST procedure to progress or move through the task, adjust the duration of the stimulus presentation time for the visual searches, and determine the statistical threshold.

As noted above, many aspects of the visual search assessment may generally be similar, or possibly even identical, to the visual search exercise task with respect to visual presentation. However, some aspects of the exercise version of visual search may not be necessary in the visual search assessment. For example, with regard to the GUI, in some embodiments, GUI elements such as score indicator, number missed, etc., may not be necessary, and so may be omitted. Features or assets that may remain the same may include the “ding” and “thump” sounds that play after a participant responds correctly or incorrectly. The assessment stimulus presentation may also be identical to the training version.

The following describes one embodiment of a 2-stair (dual track) approach for determining a psychophysical threshold for a participant, e.g., an aging adult, where the task is directed to single attention searches, and where the stimulus intensity comprises the stimulus presentation time, also referred to as duration, although it should be noted that any other attribute (or attributes) may be used as the stimulus intensity as desired. Initially, first and second tracks may be initialized with respective durations based on an initial anticipated threshold, where the initial anticipated threshold is an initial estimate or guess of a duration for visual searches corresponding to a specified performance level of the participant, e.g., a stimulus duration at which the participant fails to respond correctly some specified percentage of the time, e.g., 69%. For example, in one embodiment, the first track may be initialized to a first duration that is below the initial anticipated threshold, e.g., preferably just slightly below the initial anticipated threshold, and the second track may be initialized to a second duration that is (e.g., slightly) above the initial anticipated threshold. Thus, the initial durations of the two tracks may straddle the initial anticipated threshold.

The method elements 302-308 of FIG. 3 may be performed, as described above, where the plurality of images, including the target image (possibly as one of at least two potential target images) and a plurality of distracter images, are presented in accordance with the duration of a specified one of either the first track or the second track. In other words, one of the tracks may be selected or otherwise determined, and the stimuli for the visual search may be presented with a duration (i.e., presentation time) of or specified by the selected track. Thus, in preferred embodiments, the initial anticipated threshold, the first duration, the second duration, and the (to be determined) threshold each is or includes a respective stimulus duration or presentation time. As also described above, the participant may be required to select or otherwise indicate a location of one of the presented images (as the location of the target image) (306), and a determination may be made as to whether the participant selected the location of the target image correctly (308).

The duration of the specified track may then be adjusted or modified, based on the participant's response. For example, the duration of the track may be modified in accordance with a maximum likelihood procedure, such as QUEST or ZEST, as noted above. In one embodiment, for each track, modifying the duration of the specified track based on the participant's response may include increasing the duration if the participant responds incorrectly, and decreasing the duration if the participant responds correctly. Thus, for each assessment trial (in a given track), the duration of the search for that trial may be determined by the performance of the previous trial for that track. In other words, the participant's response to the stimulus determines that track's next stimulus duration via the maximum likelihood method.

Similar to 310 of FIG. 3, the visually presenting, requiring, determining, and modifying or adjusting (of the duration), may be repeated one or more times in an iterative manner, but in this case, the repeating is performed to determine respective final durations for the first track and the second track. For example, in one embodiment, trials in the first track and the second track may be performed in an alternating manner, or, alternatively, trials may be performed in the first track and the second track randomly with equal probability. Thus, over numerous trials, the number of trials performed in each track should be equal, or at least substantially equal. In preferred embodiments, the presenting, requiring, determining, and modifying, may be repeated until the durations of the first track and the second track have converged to values within a specified confidence interval, and where the values are within a specified distance from each other, or, until a specified number of trials have been conducted for each track. In other words, the repetition may continue until either some maximum number of trials has been performed, or until convergence conditions for the tracks have been met, both singly, and together. For example, each track may be required converge to a respective duration value, and the convergent values for the two tracks may be required to be within some distance or interval of each other.

A threshold for the participant may then be determined based on the respective final durations for the first track and the second track, where the threshold is or specifies the stimulus duration or presentation time associated with the specified performance level of the participant. For example, as mentioned above, the determined threshold may specify the duration (i.e., the presentation time) at which the participant responds correctly some specified percentage of the trials, e.g., 69%, although it should be noted that any other percentage may be used as desired. In one embodiment, the threshold for the participant may be determined by averaging the respective final durations for the first track and the second track. Note that the assessment approach described above is applicable to both Task 1 and Task 2 (or any other visual search task).

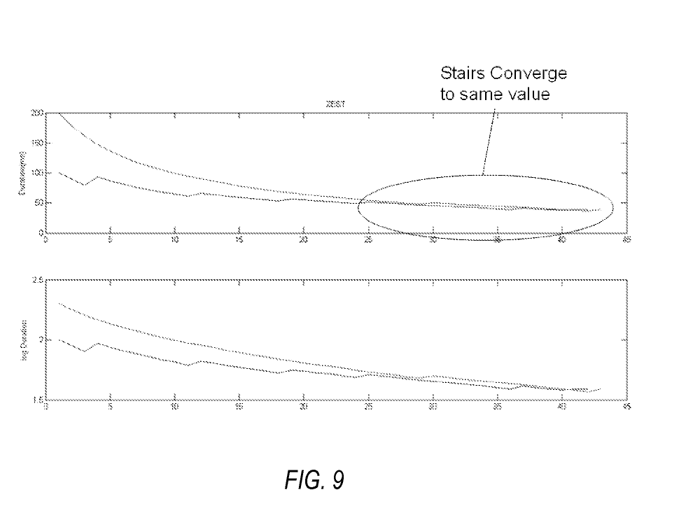

FIG. 9 illustrates an exemplary case where two tracks or “stairs” used in a ZEST threshold procedure are shown converging to a threshold value over a series of trials. Note that in the top graph, duration vs. trials is plotted in a linear manner, whereas the bottom graph provides the same information but is logarithmic on the duration (vertical) axis. As may be seen, after about 25 trials, the two tracks or stairs converge to a value at or near 50 ms, thus, the two tracks, initialized respectively to values above and below an initial estimate of the threshold, converge to an approximation of the participant's actual stimulus threshold for the exercise.

In some embodiments, the presenting, requiring, determining, and modifying may compose performing a trial, and certain information may be saved on a per trial basis. For example, in one embodiment, for each trial, the method may include saving one or more of: the current visual task, which track was used in the trial, the duration used in the trial, the number of distracter images presented to the participant in the trial, the eccentricity of the target, the visual emphasis level, the participant's selection, the correctness or incorrectness of the participant's response, the mean of a posterior probability distribution function for the maximum likelihood procedure, and the standard deviation of the posterior probability distribution function for the maximum likelihood procedure, among others. Of course, any other data related to the trial may be saved as desired, e.g., the distinguishing attribute of the target image, eccentricity of the target image, and/or any other condition of the visual search.

Additionally, in some embodiments, various parameters for the maximum likelihood procedure besides the respective (initial) durations of the two tracks may be initialized, such as, for example, the standard deviation of a cumulative Gaussian psychometric function for the maximum likelihood procedure, and/or the standard deviation of a prior threshold distribution for the maximum likelihood procedure.

In one embodiment, the method may include determining the initial anticipated threshold. For example, the initial anticipated threshold may be determined based on one or more of: the age of the participant, calibration trials performed by the participant, and/or calibration trials performed by other participants, e.g., in a “pilot” program, although it should be noted that any other type of information may be used as desired to determine the initial anticipated threshold.

In some embodiments, the method may also include performing a plurality of practice trials, i.e., prior to performing the method elements described above. For example, in some embodiments, one or more practice sessions may be performed prior to the beginning of training to familiarize the participant with the nature and mechanisms of each task. For example, in one embodiment, before training begins for each of the single attention and dual attention tasks, the participant may perform at least one practice single attention visual search session and at least one practice dual attention visual search session. In each practice session, a specified number of trials (e.g., 5) for each of one or more practice conditions may be performed. In some embodiments, the participant may be able to invoke such practice sessions at will during the exercise, e.g., to re-familiarize the participant with the task at hand.

In some embodiments, the participant may be required to show an understanding of the task by achieving a specified level of performance, referred to as a criterion level, on the initial assessment before moving on to the training exercise.

Those skilled in the art should appreciate that they can readily use the disclosed conception and specific embodiments as a basis for designing or modifying other structures for carrying out the same purposes of the present invention without departing from the spirit and scope of the invention as defined by the appended claims. For example, various embodiments of the methods disclosed herein may be implemented by program instructions stored on a memory medium, or a plurality of memory media.

We claim:

1. A method for enhancing cognition in a participant, utilizing a computing device to present visual stimuli for training, and to record responses from the participant, the method comprising:
providing a target image and a distracter image, wherein the target image and the distracter image differ in appearance, and wherein the target image and the distracter image are available for visual presentation to the participant;
visually presenting a plurality of images at respective locations in a visual field to the participant for a specified presentation time, including the target image and a plurality of distracter images based on the distracter image, wherein at the end of the specified presentation time said visually presenting is ceased;
requiring the participant to select the location of the target image from among a plurality of locations in the visual field;
determining whether the participant selected the location of the target image correctly; and
repeating said visually presenting, said requiring, and said determining one or more times in an iterative manner to improve the participant's cognition.

2. The method of claim 1, wherein said requiring comprises:
receiving input from the participant selecting a location as the location of the target image;
recording the selection made by the participant; and
recording whether the participant correctly selected the location of the target image.

3. The method of claim 1, wherein said visually presenting the plurality of image comprises visually presenting the plurality of images at a specified stimulus intensity.

4. The method of claim 3, wherein the stimulus intensity comprises the presentation time for said visually presenting.

5. The method of claim 4, wherein said repeating comprises:
adjusting the stimulus intensity for said visually presenting based on whether the participant selected the location of the target image correctly;
wherein said adjusting is performed using a maximum likelihood procedure.

6. The method as recited in claim 5, wherein the maximum likelihood procedure comprises one or more of:
a QUEST (quick estimation by sequential testing) threshold procedure; or
a ZEST (zippy estimation by sequential testing) threshold procedure.

7. The method of claim 6, wherein said adjusting the stimulus intensity comprises:
if the participant correctly selected the location of the target image, shortening the presentation time.

8. The method of claim 6, wherein said adjusting the stimulus intensity comprises:
if the participant incorrectly selected the location of the target image, lengthening the presentation time.

9. The method of claim 6, wherein said adjusting the stimulus intensity comprises:
adjusting the stimulus intensity to approach and substantially maintain a specified success rate for the participant.

10. The method of claim 9, wherein said adjusting the stimulus intensity to approach and substantially maintain a specified success rate for the participant is performed for each of a plurality of visual search conditions.

11. The method of claim 9, wherein said adjusting the stimulus intensity to approach and substantially maintain a specified success rate for the participant uses a single stair maximum likelihood procedure.

12. The method of claim 6, wherein said visually presenting, said requiring, and said determining composes performing a trial.

13. The method of claim 12, wherein said repeating comprises:
performing a plurality of trials under each of a plurality of visual search conditions, wherein each visual search condition specifies one or more attributes of the plurality of images.

14. The method of claim 13, wherein the target image differs from the distracter image in one or more of:
color;
texture;
shape;
size;
orientation; or
object type shown by the image.

15. The method of claim 14, wherein each of the visual search conditions specifies one or more of:
colors of the target image and the distracter images;
textures of the target image and the distracter images;
shapes of the target image and the distracter images;
sizes of the target image and the distracter images;
orientations of objects shown respectively by the target image and the distracter images;
object types shown respectively by the target image and the distracter images;
number of distracter images;
location of the target image;
background; and/or
visual emphasis of the target image, distracter images, and/or the background.

16. The method of claim 15, wherein selection of a location of an image is performed by the participant placing a cursor over the location and clicking a mouse.

17. The method of claim 15, wherein the visual field is partitioned into a plurality of graphically indicated regions, and wherein the location of the target image comprises a specified region of the plurality of regions in the visual field.

18. The method of claim 17, wherein selection of a location of an image is performed by the participant placing a cursor over a region containing the image and clicking a mouse.

19. The method of claim 13, wherein said performing a plurality of trials under each of a plurality of visual search conditions comprises performing a plurality of trials for each of one or more visual search tasks, wherein the one or more visual search tasks comprise one or more of:
a single attention visual search task; or
a dual attention visual search task.

20. The method of claim 19,
wherein said performing a plurality of trials under each of a plurality of visual search conditions comprises performing a plurality of trials for the dual attention visual search task;
wherein said providing a target image comprises providing at least two potential target images, wherein the at least two potential target images differ by a specified attribute, and wherein one of the at least two potential target images is the target image;
wherein said visually presenting the plurality of images in the visual field to the participant comprises:
visually presenting the plurality of distracter images;
visually presenting the at least two potential target images; and
visually presenting an indication of the specified attribute corresponding to a first potential target image of the at least two potential target images, wherein the first potential target image is the target image; and
wherein said requiring the participant to select a location of the target image from among a plurality of locations in the visual field further comprises;
requiring the participant to select a location of the first potential target image from among the locations of the at least two potential target images based on the visually presented indication.

21. The method of claim 20, wherein said visually presenting an indication of the specified attribute corresponding to a first potential target image comprises: visually presenting the indication substantially at the center of the visual field.

22. The method of claim 20, wherein the specified attribute comprises a direction of tilt of an object shown in the target image.

23. The method of claim 19, wherein said performing a plurality of trials for each of one or more visual search tasks comprises performing a plurality of trials for each of the single attention search task and the dual attention search task.

24. The method of claim 23, wherein said performing a plurality of trials for each of the single attention search task and the dual attention search task comprises:
performing trials for the single attention search task and the dual attention search task on respective alternate sessions.

25. The method of claim 23, wherein said performing a plurality of trials for each of the single attention search task and the dual attention search task comprises:
performing trials under a first number of conditions for the single attention search task, and under a second number of conditions for the dual attention search task on first alternate sessions; and
performing trials under the second number of conditions for the single attention search task, and under the first number of conditions for the dual attention search task on second alternate sessions;
wherein the first alternate sessions and the second alternate sessions are interleaved.

26. The method of claim 13, wherein said repeating comprises:
assessing the participant's performance a plurality of times during said repeating.

27. The method of claim 26, wherein said assessing the participant's performance a plurality of times is performed according to the maximum likelihood procedure.

28. The method of claim 27, wherein said assessing the participant's performance a plurality of times is performed using a 2-stair maximum likelihood procedure.

29. The method of claim 26, wherein said assessing is performed at any time during the course of training to track the participant's improvement.

30. The method of claim 1, further comprising:
prior to said visually presenting the plurality of images, presenting the target image, then removing the target image.

31. The method of claim 1, further comprising:
performing trials in one or more practice sessions for each of the one or more visual search tasks.

32. The method of claim 1, further comprising:
indicating whether the participant selected the location of the target image correctly, wherein said indicating is performed audibly and/or graphically.

33. The method of claim 1, wherein said repeating occurs a number of times each day, for a number of days.

34. A computer-readable memory medium that stores program instructions for enhancing cognition in a participant, utilizing a computing device to present visual stimuli for training, and to record responses from the participant, wherein the program instructions are executable by a processor to perform:
providing a target image and a distracter image, wherein the target image and the distracter image differ in appearance, and wherein the target image and the distracter image are available for visual presentation to the participant;
visually presenting a plurality of images at respective locations in a visual field to the participant for a specified presentation time, including the target image and a plurality of distracter images based on the distracter image, wherein at the end of the specified presentation time said visually presenting is ceased;
requiring the participant to select the location of the target image from among a plurality of locations in the visual field;
determining whether the participant selected the location of the target image correctly; and
repeating said visually presenting, said requiring, and said determining one or more times in an iterative manner to improve the participant's cognition.

35. A method for enhancing cognition in a participant, utilizing a computing device to present visual stimuli for training, and to record responses from the participant, the method comprising:
providing at least two potential target images and a distracter image, wherein the potential target images and the distracter image differ in appearance, wherein the at least two potential target images differ by a specified attribute, wherein one of the at least two potential target images is a target image, and wherein the at least two potential target images and the distracter image are available for visual presentation to the participant;
visually presenting a plurality of images at respective locations in a visual field to the participant for a specified presentation time, wherein at the end of the specified presentation time said visually presenting is ceased, said visually presenting comprising:
visually presenting a plurality of distracter images based on the distracter image;
visually presenting the at least two potential target images; and
visually presenting an indication of the specified attribute corresponding to a first potential target image of the at least two potential target images, wherein the first potential target image is the target image
requiring the participant to select the location of the target image from among a plurality of locations in the visual field, including requiring the participant to select the location of the first potential target image from the locations of the at least two potential target images based on the visually presented indication;
determining whether the participant selected the location of the target image correctly; and
repeating said visually presenting, said requiring, and said determining one or more times in an iterative manner to improve the participant's cognition.

36. A computer-readable memory medium that stores program instructions for enhancing cognition in a participant, utilizing a computing device to present visual stimuli for training, and to record responses from the participant, wherein the program instructions are executable by a processor to perform:
providing at least two potential target images and a distracter image, wherein the potential target images and the distracter image differ in appearance, wherein the at least two potential target images differ by a specified attribute, wherein one of the at least two potential target images is a target image, and wherein the at least two potential target images and the distracter image are available for visual presentation to the participant;
visually presenting a plurality of images at respective locations in a visual field to the participant for a specified presentation time, wherein at the end of the specified presentation time said visually presenting is ceased, said visually presenting comprising:
visually presenting a plurality of distracter images based on the distracter image;
visually presenting the at least two potential target images; and
visually presenting an indication of the specified attribute corresponding to a first potential target image of the at least two potential target images, wherein the first potential target image is the target image
requiring the participant to select the location of the target image from among a plurality of locations in the visual field, including requiring the participant to select the location of the first potential target image from the locations of the at least two potential target images based on the visually presented indication;
determining whether the participant selected the location of the target image correctly; and
repeating said visually presenting, said requiring, and said determining one or more times in an iterative manner to improve the participant's cognition.
